(19) United States
(12) Patent Application Publication
(10) Pub. No.: US 2009/0308472 A1
(43) Pub. Date: Dec. 17, 2009

(54) Swirl Inducer

(76) Inventor: Jayden David Harman, San Rafael, CA (US)

Correspondence Address: CARR & FERRELL LLP, 2200 GENG ROAD, PALO ALTO, CA, 94303, US

(21) Appl. No.: 12/484,998

(22) Filed: Jun. 15, 2009

Related U.S. Application Data
(60) Provisional application No. 61/061,630, filed on Jun. 15, 2008.

(51) Int. Cl. F15C 1/16

(52) U.S. Cl. 137/808

(57) ABSTRACT

A swirl inducer or mixer for location within a tube or duct. The swirl inducer may extend within the tube or duct and has an active surface over which a fluid flows to induce a swirling vortical flow within the fluid. The swirl inducer induces vortical flow in the tube or duct, which conforms with the path of least resistance and minimizes the amount of energy that is applied to the fluid to cause it to flow through the tube or duct and that causes the greatest, most rapid mixing of fluids passing through the tube or duct.

### CROSS-REFERENCE TO RELATED APPLICATIONS

The present application claims the priority benefit of U.S. provisional patent application No. 61/061,630 filed Jun. 15, 2008 and entitled “Swirl Inducer.” The disclosure of the aforementioned application is incorporated herein by reference.

### BACKGROUND OF THE INVENTION

1. Field of the Invention

The present invention generally relates to fluid mechanics. More specifically, the present invention relates to a swirl inducing structure, which may be located in a tube or duct.

2. Description of the Related Art

Fluid flow within a tube or duct is generally most efficient when in a state of laminar flow. In certain situations, however, it is necessary for the fluid to be in a state of non-laminar flow. Such a situation includes a tube or duct involved in the exchange of heat between the tube or duct walls and a fluid whereby inducing a certain degree of turbulence in the flow may lend to an increase in the mixing of fluids thereby increasing the transfer of heat energy between the fluid and the tube or duct wall. A similar circumstance arises where a fluid flow involves an entrained medium or is a mixture. Inducing turbulence may be desirable in order to prevent the stratification of the flowing fluid whereby the fluid maintains certain constant characteristics.

Turbulence can be effectuated in these instances through the introduction of a swirl inducer (or inducers) into the flow path of a fluid. Such inducers have generally been placed at the entry point of a tube or duct conveying a fluid, continuously along the interior of the tube or duct, or at one or more positions along the tube or duct as well as in varying combinations of the three. Introducing a swirl inducing device into a flow path, however, reduces the overall efficiency of the fluid flow through the tube or duct.

Unsatisfactory degrees of drag and friction are generated thereby requiring additional force to maintain requisite fluid flow. Areas of backpressure may also result thereby resulting in stagnant zones of fluid contained by a tube or duct. Such prior art arrangements also create blockages within the tube or duct through the buildup of scale or similar deposits on the surfaces of the swirl inducers and/or in the tube or duct. These buildups and deposits lend to the inevitable need for repairs and cleanouts, which result in certain fluid pathways being taken entirely out of operation.

In the context of improving the transfer of heat energy, swirl inducers have been utilized, as noted above, to maximize turbulence in a fluid thereby enhancing mixing and corresponding heat exchange. The efficiency of prior art swirl inducing structures in effectuating heat transfer is limited, however, as prior art swirl inducing structures require considerable surface area. These large structures are not particularly efficient due to the restrictions that they present to the flow of the fluid past the swirl inducing structure not to mention the requisite size of a corresponding duct or tube.

There is a need in the art for a swirl inducing mechanism that overcomes the unsatisfactory compromise brokered by prior art inducers with respect to a rate of fluid flow, induction of turbulence, friction, drag, backpressure, stagnation, particulate buildup, and size of the inducer.

### BRIEF DESCRIPTION OF THE DRAWINGS

FIG. 1A illustrates a logarithmic spiral, as known in the prior art.

FIG. 1B illustrates a particular type of logarithmic spiral, as known in the art, wherein the radius of the logarithmic spiral measured at equiangular radii unfolds at a constant order of growth.

FIG. 1C illustrate a whirling rectangle as known in the art.

FIG. 1D illustrates a Fibonacci spiral as known in the art.

FIG. 2 is a schematic side view of a natural vortex, which conforms to the Golden Section.

FIG. 3 is a graph depicting the geometric progression ratio of the structure of a two dimensional Golden Section vortex, said vortex generally corresponding to that of FIG. 2.

FIG. 4 illustrates a side view of an embodiment of swirl inducer.

FIG. 5 illustrates a plan view of the swirl inducer of FIG. 4.

FIG. 6 illustrates a perspective view of the swirl inducer of FIG. 4.

FIG. 7 illustrates a series of swirl inducers like those of FIG. 4 disposed within a fluid pathway.

FIG. 8 illustrates a fluid pathway including a number of swirl inducers not configured in accordance with the likes of the Golden Section thereby resulting in turbulent flow.

FIG. 9 illustrates a fluid pathway including a number of swirl inducers configured in accordance with the likes of the Golden Section thereby resulting in non-turbulent flow, like that of FIG. 7.

FIG. 10 illustrates a perspective view of an alternative embodiment of a swirl inducer, said swirl inducer being implemented in a non-circular fluid pathway.

FIG. 11 illustrates non-turbulent flow resulting from implementation of the swirl inducer of FIG. 10 in a non-circular fluid pathway.

FIG. 12 illustrates flow distribution of the swirl inducer of FIG. 10.

### DETAILED DESCRIPTION

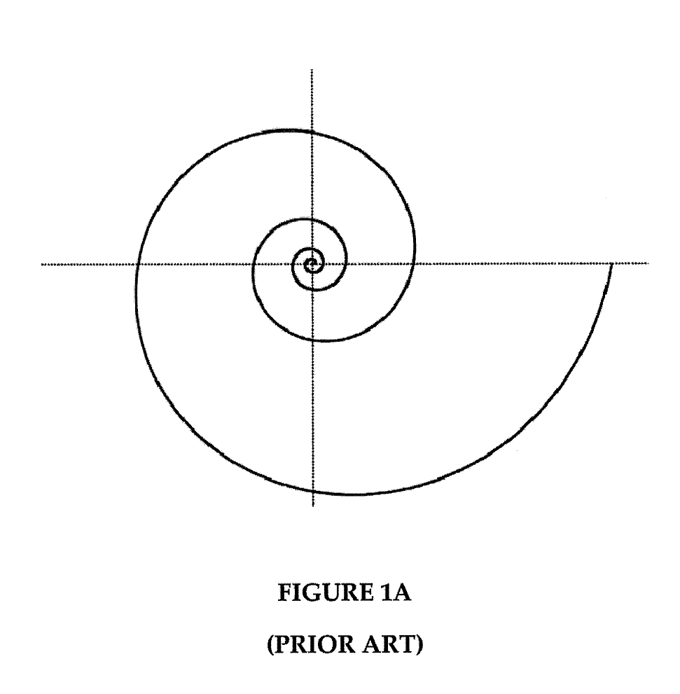

FIG. 1A illustrates a logarithmic spiral, as known in the prior art. FIG. 1B, however, illustrates a particular type of logarithmic spiral, also known in the art, wherein the radius of the logarithmic spiral measured at equiangular radii unfolds at a constant order of growth. A logarithmic spiral (sometimes referred to as an equiangular spiral or growth spiral) like that of FIG. 1A is a special kind of spiral curve that often appears in nature. A Golden Spiral—a spiral in accord with the Golden Section or Golden Ratio—like that depicted in FIG. 1B is a type of logarithmic spiral where two quantities are in golden ratio. Two quantities are in golden ratio or embody the Golden Ratio if the ratio of the sum of the quantities to the larger one equals the ratio of the larger one to the smaller. The golden ratio is an irrational mathematical constant, which approximates 1.6180339887 and is often denoted by the Greek letter phi (φ).

This constant, when expressed algebraically reads:

$$\frac{a + b}{a} = \frac{a}{b} = ϕ .$$

This equation has as its unique positive solution the algebraic irrational number

$$ϕ = \frac{1 + \sqrt{5}}{2} \approx 1.6180339887 …$$

A logarithmic spiral like that of FIG. 1B is sometimes referred to as the Golden Section, the Golden Ratio, or a Golden Spiral. As noted above, the order of growth of the radius of the curve that is measured at equiangular radii is constant as the spiral unfolds. This growth can be illustrated from the triangular representation of each radius between each sequence which corresponds to the formula of a:b=a+b:a, and is consistent throughout the curve.

The polar equation for a logarithmic spiral like that of FIG. 1B and conforming to the Golden Section is the same for other logarithmic spirals, but with a special value of b as illustrated below:

$$r = a {e}^{b θ} , or$$

$$θ = \frac{1}{b} ln ( r / a ) ,$$

wherein e is the base of natural logarithms, a being an arbitrary positive real constant, and b such that when θ is a right angle (a quarter turn in either direction):

e^{bθ}^{_{right}}=φ

Therefore, b is given by:

$$b = \frac{ln φ}{{θ}_{right}} .$$

The numerical value of b depends on whether the right angle is measured as 90 degrees or as π/2 radians; and since the angle can be in either direction, it is easiest to write the formula for the absolute value of b (that is, b can also be the negative of this value):

$$\vert b \vert = \frac{ln φ}{90} = 0.0053468 for θ in degree ;$$

$$\vert b \vert = \frac{ln φ}{π / 2} = 0.306349 for θ in radians .$$

An alternate formula for a logarithmic and golden spiral is:

r=ac^{θ}

where the constant c is given by:

c=e^{b}

which for the golden spiral gives c values of:

$$c = {φ}^{\frac{1}{00}} \approx 1.0053611$$

if θ is measured in degrees, and

$$c = {φ}^{\frac{2}{π}} \approx 1.358456 .$$

if θ is measured in radians.

There are several spirals in the art that approximate, but that do not exactly equal a Golden Spiral. For example, a Golden Spiral can be approximated by a ‘whirling rectangle diagram’ like that of FIG. 1C, wherein the opposite corners of squares formed by spiraling golden rectangles are connected by quarter-circles. Another approximation is a Fibonacci Spiral (FIG. 1D), which is not a true logarithmic spiral for at every quarter turn the spiral increases in width not by φ, but by a changing factor related to the ratios of consecutive terms in the Fibonacci sequence. The ratios of consecutive terms in the Fibonacci series approach φ, so that the two spirals are very similar in appearance.

The swirl inducers and swirl inducing systems of the present disclosure induce optimized mixing and energy transfer and reduce back pressure by channeling the fluids into their natural flow tendencies by full or partial adherence to equiangular and logarithmic paths of movement.

The swirl inducers disclosed herein may be located within an existing tube or duct at or proximate the entry into the tube or duct. The swirl inducer may include a vane intended to extend across the flow path of the fluid entering the tube or duct to effectuate a vortical flow into the fluid flowing along the tube or duct subsequent to passage past the swirl inducer. The vane may have at least one surface in the general form of a spiral or helix extending along a portion of the length of the tube or duct.

That surface (the active surface) may interact with the aforementioned fluid flow. The active surface may include a curvature that conforms substantially with a logarithmic curve conforming to the Golden Section (i.e., unfolding at a constant order of growth where the radius of the curve is measured at equiangular radii). The active surface may alternatively embody an equiangular spiral such as those found in the curves of an inner or outer seashell surface.

Shell configurations may be selected from the phylum Mollusca, class Gastropoda or Cephalopoda. Alternatively, configurations may be selected from shells of the genera Volutidea, Argonauta, Nautilus, Conidea or Turbinidea. These active surfaces, as a result of their interaction with the fluid flow, may cause rotational and vortical flow in the fluid passing by the vane. In some embodiments, the active surface of the vane may have the configuration of a whorl.

The swirl inducer may include a short longitudinal dimension relative to the length of the tube or duct. According to one embodiment of the invention the longitudinal dimension of the swirl inducer is substantially the same as the transverse dimension of the swirl inducers. Alternatively, the swirl inducer may have a long longitudinal dimension relative to the length of the tube or duct and the vane extends along a significant portion of the tube or duct. The swirl inducer may extend across substantially the full transverse extent of the tube or duct or partially across the transverse extent of the tube or duct.

The swirl inducer may include a plurality of vanes defining a flow path between themselves wherein the flow path has a curvature which is in substantial conformity with the Golden Section. The swirl inducer may include a plurality of vanes supported in spaced axial relationship from a support which is adapted to be fixed to the tube or duct such that the swirl inducers are located at spaced intervals along the length of the tube or duct. The inducer may include a plurality of vanes supported in side by side relationship from a support which is adapted to be fixed to the tube or duct such that the swirl inducers are across the width of the tube or duct. The tube may have an oval-like or rectangular-like cross sectional configuration in which one transverse dimension is greater than another transverse dimension which is perpendicular to the first dimension.

Embodiments of the presently disclosed swirl inducer may be mounted within a duct or flow pathway such as a heat exchanger. While the presently disclosed swirl inducers may be mounted or arranged in a fashion similar to those found in the prior art, the actual configuration and design of those inducers allow for fluids to move more naturally including within the confines of unnaturally configured passageways such as a parallel-sided conduit. Common place inefficiencies encountered by prior art swirl inducing mechanisms are reduced through the inducers of the present disclosure, which may be configured to induce a spiral or vortical flow of fluid.

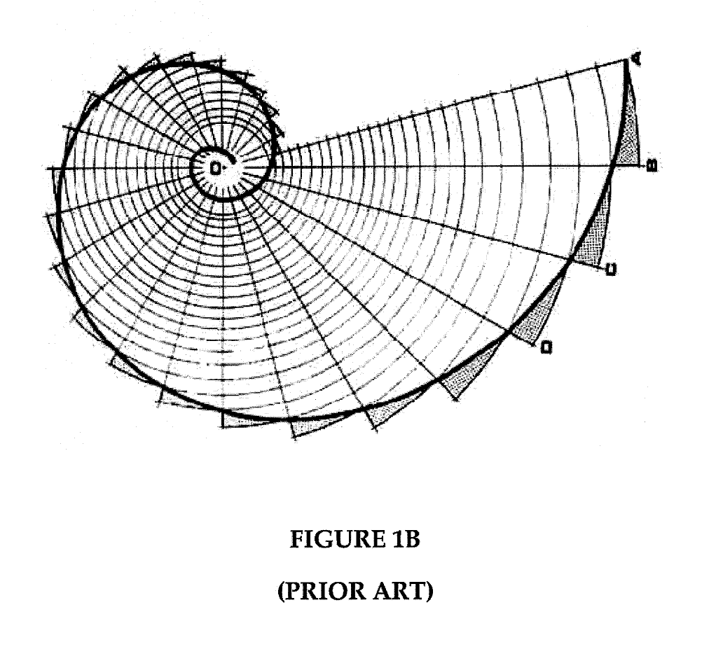

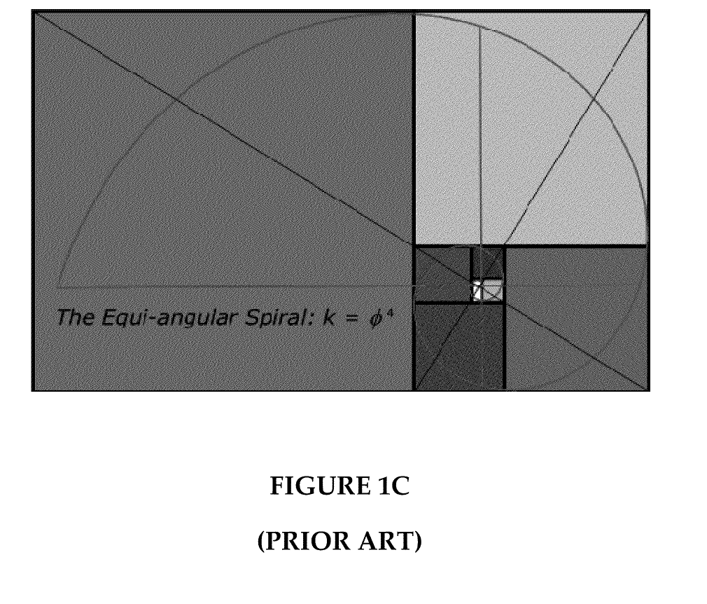

The streamlines of an induced fluid may conform to one or more dimensions of the Golden Section or similar logarithmic spiral. The more perfect the spiral (i.e., truly corresponding to the Golden Section), the more natural the fluid flow. An example of such a fluid flow is that of a tornado (as shown at FIGS. 2 and 3) where an intense flow of fluid is generated. FIG. 2 illustrates a schematic side view of a natural vortex, which conforms to the Golden Section, whereas FIG. 3 is a graph depicting the geometric progression ratio of the structure of a two dimensional Golden Section vortex, generally corresponding to that of FIG. 2.

When a fluid is caused to flow over a pathway (or pathways) having a curvature conforming substantially or in part to that of the Golden Section or a similar logarithmic configuration, the fluid flows over those configured surfaces in a substantially non-turbulent fashion. The flowing fluid has a decreased tendency to cavitate and traverses the pathway more efficiently than a fluid in a pathway that does not substantially correspond, or at least in part, to that of the Golden Section or some other logarithmic spiral.

If a fluid is caused to adopt a vortical flow pattern having a curvature corresponding substantially or in part to that of the Golden Section while flowing through a conventional conduit (e.g. one having parallel sides), the flow though that conduit is more efficient than in a circumstance where the flow has the characteristics of laminar flow. There is a resulting reduction in the likelihood of stratification of the fluid within the conduit. Fluid flowing though the conduit tends to a state of uniformity in terms of heat content and entrained materials (i.e., optimized mixing of the fluid/fluids and other materials contained).

An embodiment of the presently disclosed swirl inducers include a curvature, which may referred to as an active surface. The surface itself is not necessarily active in and of itself, but invokes action (or reaction) with respect to a fluid in contact with the same. The active surface is configured in accordance with the Golden Section or some other logarithmic spiral thereby providing a fluid pathway that is of a spiraling configuration. The active surface of the inducer may include vanes arranged two dimensionally or three dimensionally with respect to the Golden Section or other logarithmic spiral. Any number of variations in the cross-sectional area of the fluid pathway may also conform substantially or in part to certain characteristics of the Golden Section or other logarithmic spiral. Exemplary active surface and pathway configurations include those corresponding to the internal and/or external configurations of shells of the phylum Mollusca, classes Gastropoda and Cephalopoda.

As a result of passage of the fluid into a tube from a swirl inducer according to embodiments of the presently disclosed invention, the fluid is caused to adopt a vortical or spiraled flow through the tube that generally corresponds to the Golden Section or a similarly logarithmic configuration.

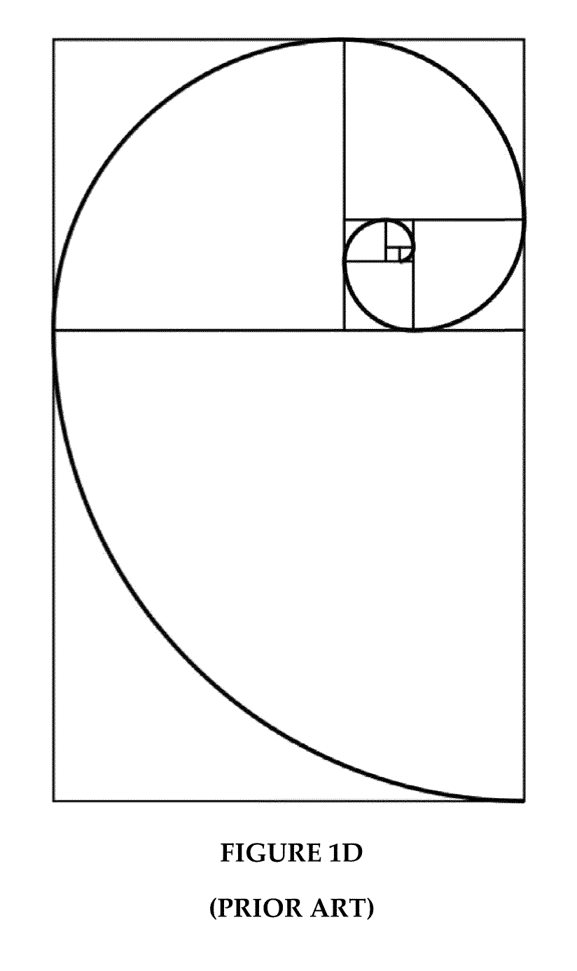

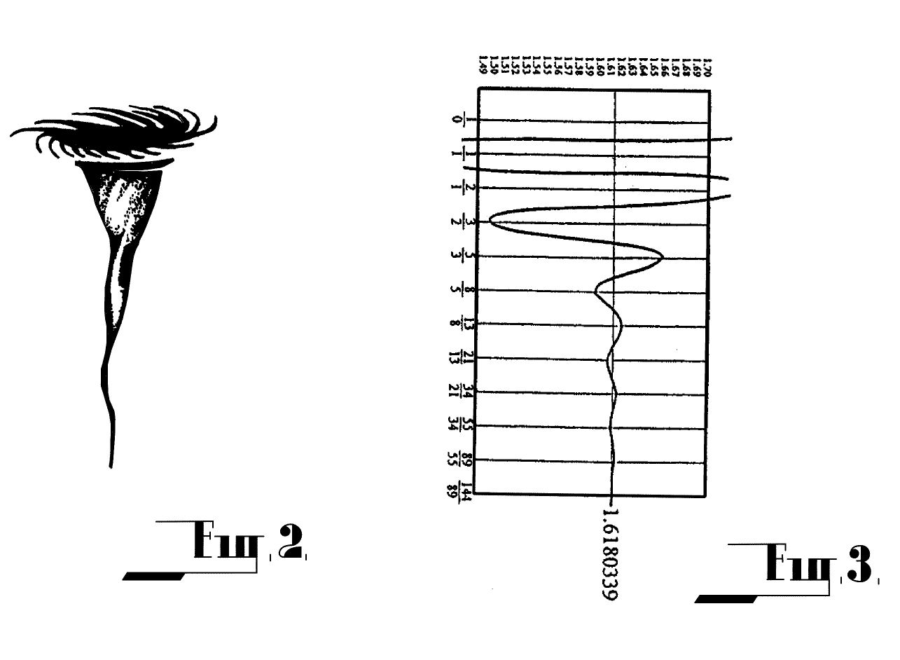

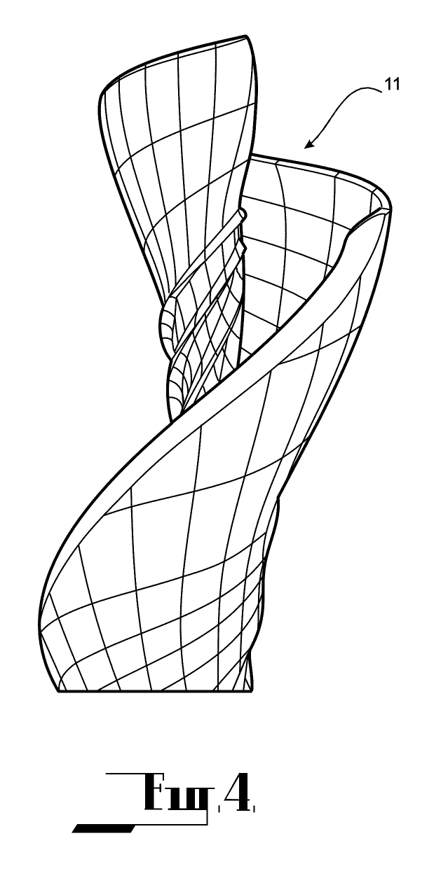

FIGS. 4, 5, and 6 illustrate an embodiment of a swirl inducer 11 viewed from the side, plan view, and perspective view, respectively. The swirl inducer illustrated in FIGS. 4-6 corresponds in shape to a vane that may induce a swirling or non-laminar effect. The inducer has an active surface configured corresponding to a logarithmic spiral, including that of the Golden Section as illustrated in the context of FIG. 1B, specifically. The active surface of the swirl inducer of FIGS. 4-6 is arranged in such a way that it a central portion that corresponds to a cavitation center of a vortex or windings or septa of a volute, cone, or other shell as might be selected from the genera of phylum Mollusca, classes Gastropoda and Cephalopoda.

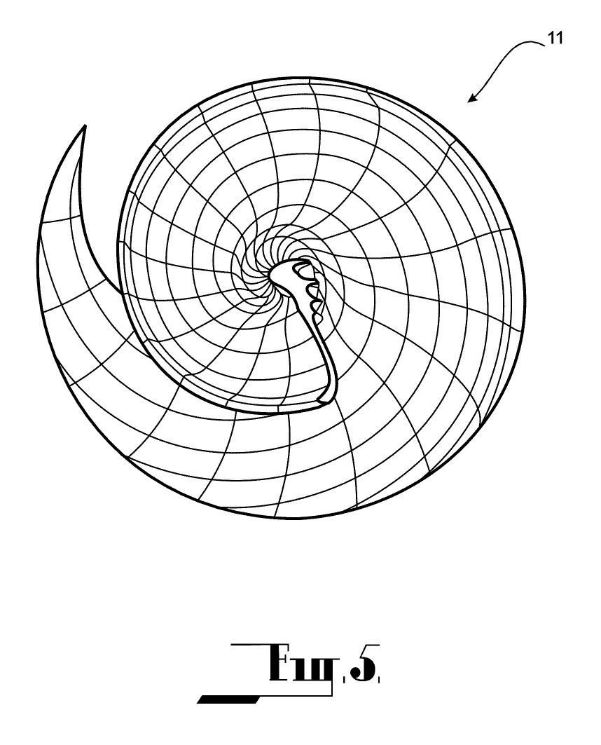

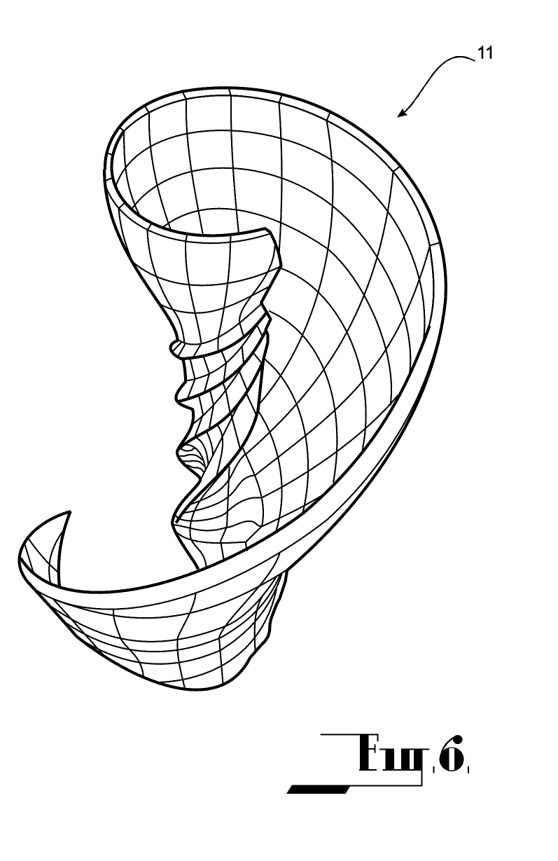

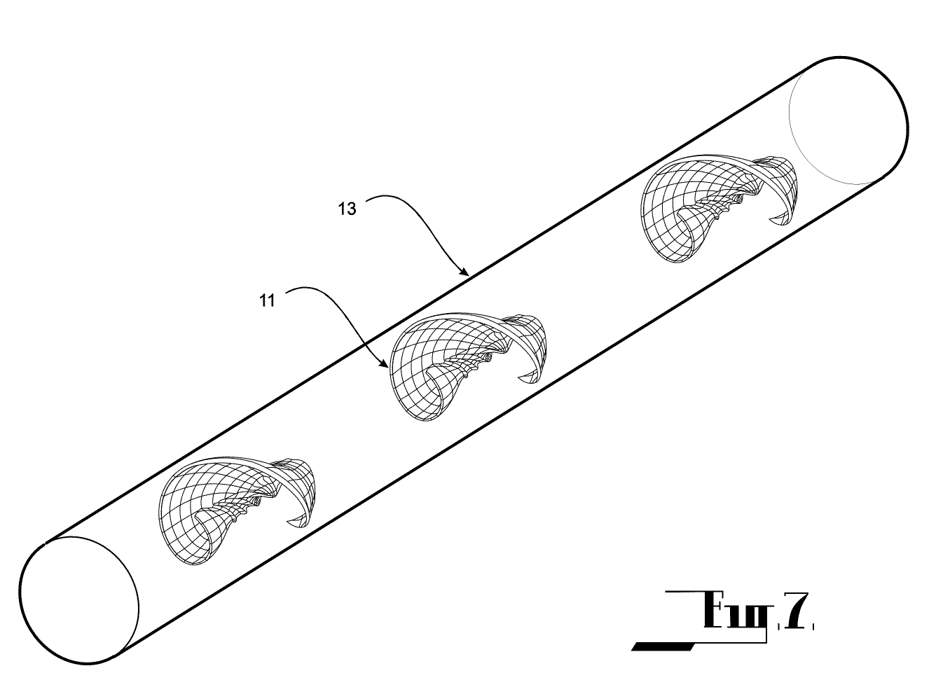

FIG. 7 illustrates a series of swirl inducers 11 like those of FIG. 4 disposed within a fluid pathway 13. The swirl inducers 11 may be located within the pathway 13 having a circular internal cross section such that the inducers 11 are located at evenly spaced intervals along the length of the fluid pathway 13. More sporadic placements of the inducers 11 within the pathway 13 may be implemented. As a fluid flows over the active surfaces of the inducers 11, the fluid is caused to swirl as it moves from one end of the inducer 11 to the other and as it does, the fluid will be caused to rotate in a vortical manner to move from the centre of the flow path to the lateral outer limits of the flow path. When one or more such inducers 11 are positioned at spaced intervals along a portion of the pathway 13 as shown in FIG. 7, fluid flowing into the pathway 13 will be caused to undergo a vortical, non-turbulent swirling motion whereby the fluid flows between the centre of the tube and the inner face of the tube and, in the case of a heat exchanger, serves to convey heat throughout the fluid. An exemplary and resultant flow pattern is shown at FIG. 9. In comparison, FIG. 8 illustrates a swirl inducer system including an equal number of vanes that are not in conformity with the Golden Section or naturally configured logarithmic spiral thereby resulting in the creation of a turbulent flow within the tube.

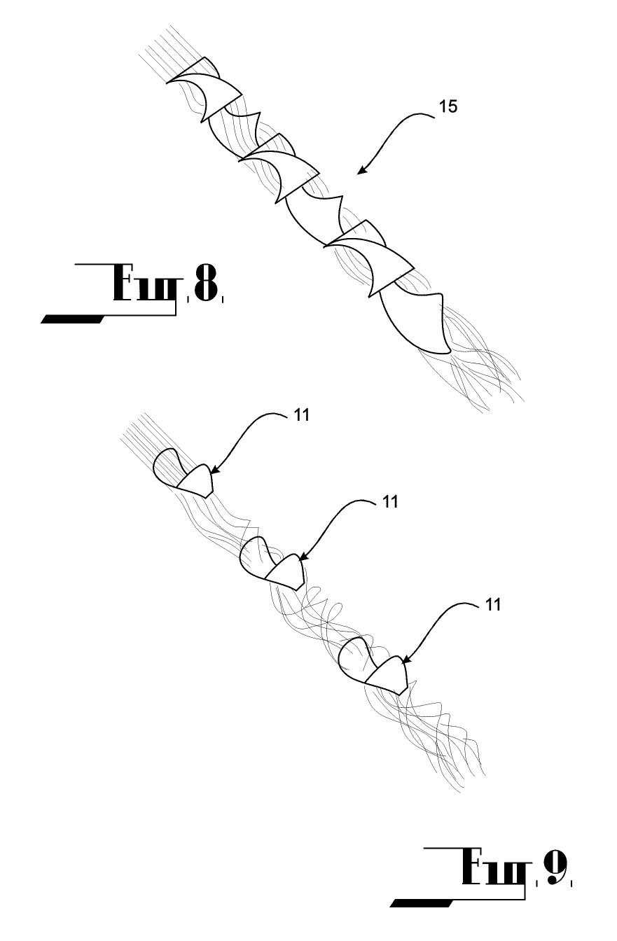

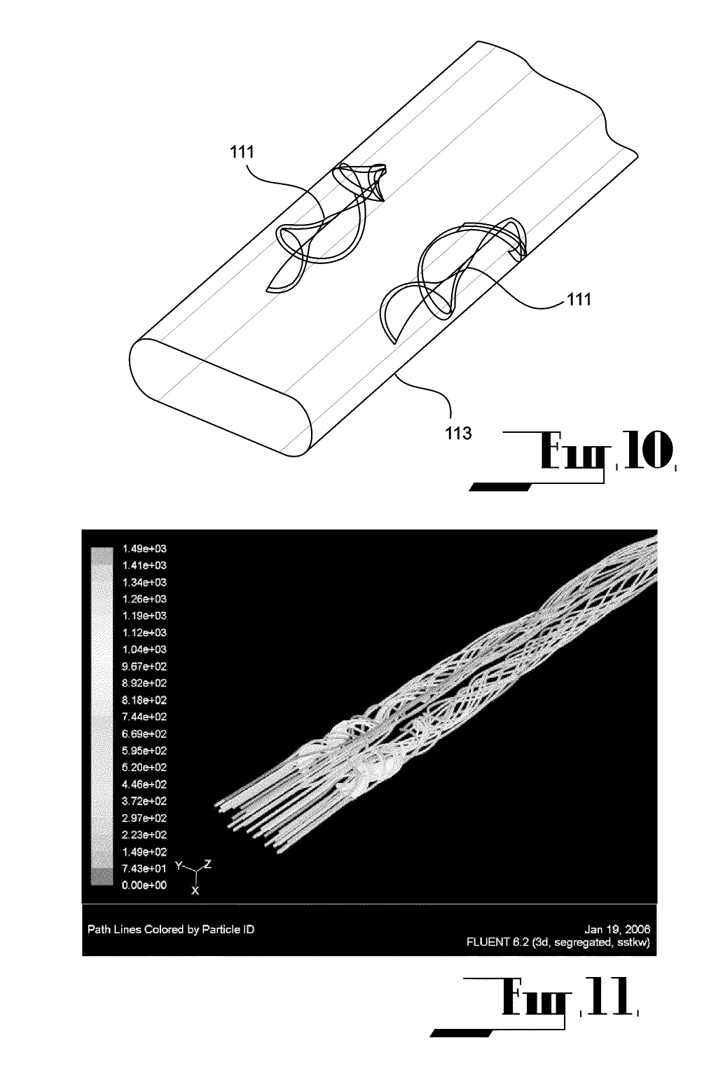

FIG. 10 illustrates a perspective view of an alternative embodiment of a swirl inducer 111, said swirl inducer being implemented in a non-circular fluid pathway 113. FIG. 11 illustrates non-turbulent flow resulting from implementation of the swirl inducer of FIG. 10 in a non-circular fluid pathway. The swirl inducer 111 of FIG. 10 may be used with heat exchange tubes or pathways that have a generally rectangular cross section. Such tubes may be found in a compact heat exchanger tubes. Such a tube/pathway 113 is shown at FIG. 10 and has an aspect ratio of 3 (i.e., 3 times wider than it is deep).

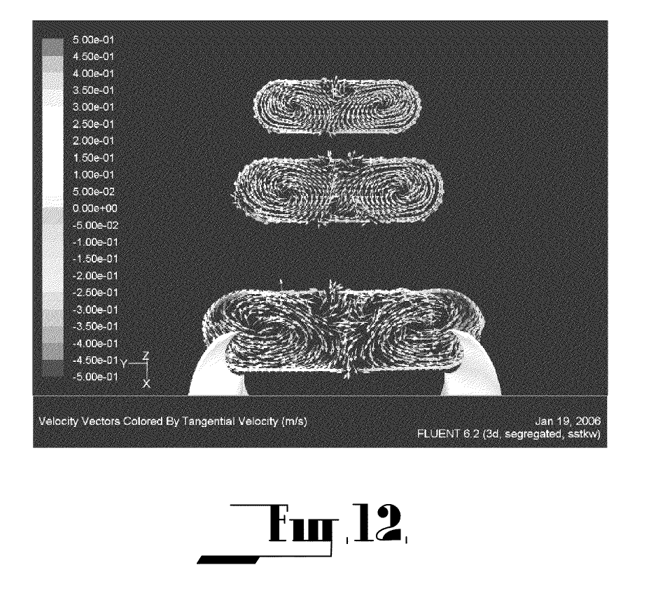

The tube/pathway 113 of FIG. 10 has the advantage over a circular cross section tube of equivalent cross sectional area in that it has higher surface area to volume ratio and allows for a better placement of vanes or other active surfaces along the swirl inducer 111. The embodiment of the swirl inducer 111 shown at FIG. 10 includes a pair of vanes conforming to the configuration of the vanes of the swirl inducer 11 of the first embodiment in a side-by-side relationship and located adjacent the most remote sides of the flow path. The vanes are positioned such that they are of opposite bias and will together induce two contra-rotational vortical fluid flow along the adjacent halves of the pathway 113 as is shown in FIG. 11. The resultant vortices act to condition the flow such that the fluid in the centre of the pathway 113 is continuously moved to the outer walls as shown in FIG. 12, which illustrates flow distribution of the swirl inducer of FIG. 10. Thus the fluid at the walls is continuously changed and a layer of relatively cold fluid does not form.

The swirl inducer of the present invention may include any number of vanes. The active surface of any given vane may vary in width along the length of the vane may also increase or decrease in profile width. These flow inducing systems may be used in conduits that are intended to receive fluids which are mixtures of fluids of different phases (e.g. gaseous fluids and liquid fluids) or fluids of the same phase but which are immiscible, emulsions, suspensions, or slurries.

While various embodiments have been described herein, it should be understood that they have been presented by way of example only, and not limitation. Thus, the breadth and scope of any disclosed embodiment should not be limited by the specification but only by the claims presented herewith.

What is claimed is:

1. A system for inducing a change in fluid flow, the system including a series of swirl inducers.
